(19) United States
(12) Patent Application Publication
(10) Pub. No.: US 2013/0253385 A1
(43) Pub. Date: Sep. 26, 2013

(54) MOTORIZED EXOSKELETON UNIT

(71) Applicants: Amit Goffer, Kiryat Tivon (IL); Oren Tamari, Pardesia (IL)

(72) Inventors: Amit Goffer, Kiryat Tivon (IL); Oren Tamari, Pardesia (IL)

(21) Appl. No.: 13/426,071

(22) Filed: Mar. 21, 2012

(51) Int. Cl. A61H 1/02

(52) U.S. Cl. 601/35

(57) ABSTRACT

A motorized exoskeleton device comprising: at least two segments, where one segment is superior to the other, the exoskeleton device configured to be coupled to a lower extremity of a user. The exoskeleton device further comprising at least two motorized joints for connecting the at least two segments and for providing relative angular movement between the at least two segments; and the motors coupled to the same superior segment of the exoskeleton device.

### FIELD OF THE INVENTION

The present invention relates to a device and method for walking assistance and locomotion. More particularly, the present invention relates to a device and method for overcoming impeded locomotion disabilities.

### BACKGROUND OF THE INVENTION

About two million people in the USA alone are confined to wheelchairs that serve as their only means of mobility. As a result, their lives are full of endless obstacles such as stairs, rugged pavement and narrow passages. Furthermore, many disabled people lack the ability to remain in a standing position for long periods of time, and often have only limited upper-body movements.

Typically, attempts by disabled persons to remain standing for long periods of time often inflict hazardous health complications. In order to prevent rapid health deterioration, expensive equipment such as standing frames and trainers must often be used in addition to ample physio/hydro-therapy.

Typically, rehabilitation devices for disabled persons confined to wheelchairs as well as available devices in rehabilitation institutions are used for training purposes only. A solution that enables daily independent activities that restore the dignity of handicapped persons, dramatically ease their lives, extend their life expectancies and reduce medical and other related expenses is so far not available.

### SUMMARY OF THE INVENTION

The invention relates generally to motorized exoskeletons for restoring and/or assisting upright mobility among individuals with impaired lower limbs. In particular the invention relates to the positioning of motor units within the exoskeleton device.

### BRIEF DESCRIPTION OF THE DRAWINGS

Examples of the present invention are described in the following detailed description and illustrated in the accompanying drawings in which:

FIG. 1 is a schematic illustration of an exoskeleton unit coupleable to a user, according to an example;

FIG. 2 is a schematic illustration of an exoskeleton unit, according to an example; and,

FIG. 3 depicts a close-up of a segment, typically a thigh segment.

It will be appreciated that for simplicity and clarity of illustration, elements shown in the figures have not necessarily been drawn to scale.

For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

A motorized exoskeleton unit may be a motorized brace system for the lower body and lower limbs that may be typically attached to the user's body, in some examples, under the clothes. In some examples, the motorized exoskeleton unit may be attached to the body of the user on top of the clothing.

Typically, motorized exoskeleton unit may be useful in facilitating a user's locomotion.

In some examples, the use of the motorized exoskeleton unit may enable the user to restore some or all of their daily activities, especially stance and gait abilities.

In some examples, the motorized exoskeleton unit may enable a non-disabled user to exert forces greater than their muscles can currently provide. In some examples, the motorized exoskeleton unit may enable a non-disabled user to exert standard forces with less than typical effort.

In addition to stance and locomotion, the motorized exoskeleton unit supports other mobility functions such as upright position to sitting position transitions and stairs climbing and descending.

The motorized exoskeleton unit typically may suit disabilities such as paraplegia, quadriplegia, hemiplegia, polio-resultant paralysis, and in some applications, individuals with difficult to severe mobility issues.

In some examples, the motorized exoskeleton unit allows vertical stance and locomotion by means of an independent device that generally comprises a detachable light supporting structure as well as propulsion and control means.

In some examples, the motorized exoskeleton unit may be used in conjunction with other devices. Typically, other devices may provide additional support and/or mobility. In some examples, other devices may provide other functions, as are known in the art.

Typically, the use of the motorized exoskeleton unit may make it possible to relieve the incompetence of postural tonus as well as reconstituting the physiological mechanism of the podal support and walking. Consequently, the device, may, in some examples, reduce the need for wheelchairs among the disabled community. The motorized exoskeleton unit may provide a better independence to the user and the ability to overcome obstacles such as stairs and/or other obstacles as are known in the art.

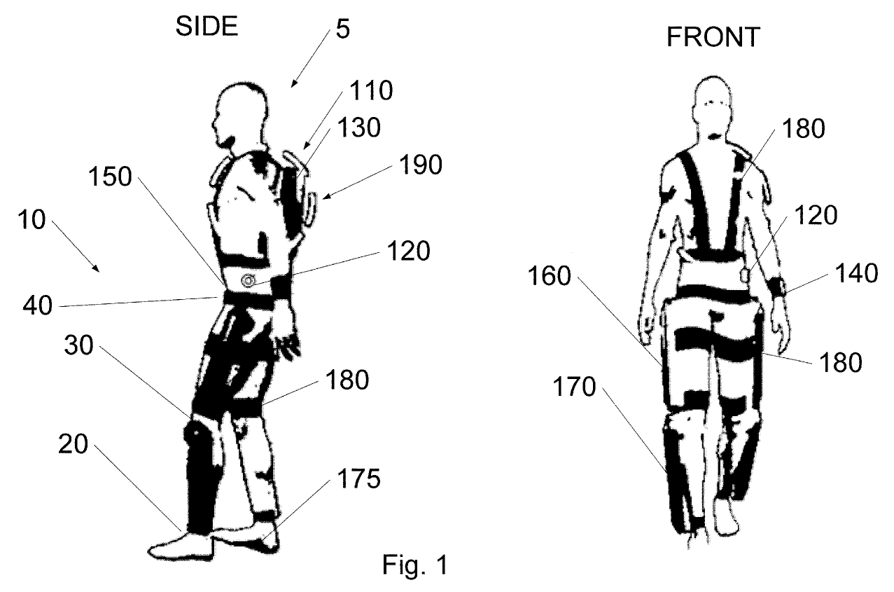

FIG. 1 is a schematic illustration of an example of a motorized exoskeleton unit coupled to a user, showing the front view and side view of the user, according to an example.

Typically, motorized exoskeleton unit 10 typically includes a pair of limb members configured to be coupled to a lower extremity of the user. In some example, there may be only a single limb member.

Typically, motorized exoskeleton unit 10 includes a relatively small control unit 110, mounted on the body of the user 5 typically a person. In some examples, a relatively small control unit 110 may be mounted coupled to or inserted in backpack 130. In some examples, control unit 110 may not be relatively small. In some examples, control unit 110 may be known in the art.

Typically, control unit 110 executes programs and algorithms, the programs and algorithms as are known in the art, via an incorporated processor.

In some examples, the incorporated processer may constantly, or at intervals, interact with movements of the upper part of the body. With the incorporated processer constantly, or at intervals, interacting with movements of the upper part of the body, walking patterns and stability may be achieved with the help of user 5.

In some examples, control unit 110 commands motorized exoskeleton unit 10 via power drivers. Typically, control unit 110 may contain or, in some examples, be coupled to dedicated electronic circuitry.

In some examples, control unit 110 may be coupled to one or a plurality of sensor units, e.g. a tilt sensor 120, which contains various sensors. Typically, the sensors include and/or may be similar to other sensors known in the art. In some examples, the sensor unit may monitor parameters of motorized exoskeleton unit 10. Typically, the monitored parameters of motorized exoskeleton unit 10 may include torso tilt angle, articulation angles, motor load and warnings and other parameters known in the art.

In some examples, the sensor unit may transfer information regarding monitored parameters of motorized exoskeleton unit 10 to control unit 110 via feedback interfaces. The feedback interfaces as are known in the art.

In some examples, motorized exoskeleton unit may include one or plurality of joints.

The one or plurality of joints in the motorized exoskeleton unit 10 may include, for example, ankle joint 20, knee joint 30, or hip joint 40. In some examples, motorized exoskeleton unit 10 may also be provided with one or a plurality of angle sensor for sensing a relative angle between segments connected by the one or plurality of joints: ankle joint 20, knee joint 30, or hip joint 40.

In some examples, an output signal from at least one of the angle sensors may be communicated to control unit 110. The output signal may indicate a current relative angle between connected segments.

In some examples, tilt sensor 120 may be mounted on user 5 or on a brace, as described below. Typically, tilt sensor 120 may be located on any component of motorized exoskeleton unit 10 whose angle of tilt reflects the angle of tilt of the trunk support of motorized exoskeleton unit 10. An output signal from the tilt sensor may be communicated to the control unit. In some examples, the output signal may indicate an angle between the trunk of the user and the vertical. In some examples, the output signal may indicate an angle between the whole exoskeleton and the vertical to the ground.

In some examples, motorized exoskeleton unit 10 may include one or more additional auxiliary sensors. The auxiliary sensors may include one or a plurality of pressure-sensitive sensors. The one or a plurality of pressure-sensitive sensors as may be known in the art. Typically, a pressure-sensitive sensor may measure a ground force exerted on motorized exoskeleton unit 10. In some examples, the ground force sensor may be included in a surface designed for attachment to the bottom of the user's foot.

Typically, control unit 110 may be located in a backpack of motorized exoskeleton unit 10. Alternatively, components of the control unit may be incorporated into various components of motorized exoskeleton unit 10. In some examples, control unit 110 may include a plurality of intercommunicating electronic devices. The intercommunication between control unit 110 and plurality of intercommunicating electronic devices may be wired or wireless.

In some examples, communication between control unit 110 and components of motorized exoskeleton unit 10 such as knee motor unit 90 and hip motor unit 100 as described below, and sensors, and/or other components of motorized exoskeleton unit 10 may be wired or wireless.

In some examples, communication between different components of control unit may be wired or wired.

Typically, motorized exoskeleton unit 10 may include a Man Machine Interface, MMI. In some examples, the MMI may be, for example, a remote control 140 through which the user controls modes of operation and parameters of motorized exoskeleton unit 10. In some examples, the controlled modes of operation and parameters of motorized exoskeleton unit 10 by a Man Machine Interface or remote control 140 may include gait mode, sitting mode and standing mode, or other modes known in the art.

Remote control 140 may include one or more pushbuttons, switches, touch-pads. In some examples, remote control 140 may include other similar manually operated controls that a user may operate. Typically, the operation of remote control 140 may generate an output signal, or other signals known in the art for communication to control unit 110.

Typically, a communicated signal between remote control 140 and control unit 110 may indicate a user request to initiate or continue a mode of operation. For example, a communicated signal between remote control 140 and control unit 110 may indicate a command to initiate walking, or in some examples, a command to continue a walking forward, or other operations known in the art, when appropriate sensor signals are received. In some examples, a communicated signal between remote control 140 and control unit 110 may include a control for turning motorized exoskeleton unit 10 on or off. In some examples, a communicated signal between remote control 140 and control unit 110 may include a control for turning motorized exoskeleton unit to remain in a stand-by phase.

Typically, for communicating a signal between remote control 140 and control unit 110, remote control 140 may be designed for mounting in a location that is readily accessible by the user. For example remote control 140 may be placed and/or secured in a particular location with a band or strap, or other methods of securing items as are known in the art.

In some examples, remote control 140 may include several detached controls, each detached control in remote control 140 may be configured for communicating separately with control unit 110 and each detached control in remote control 140 may be configured to be mounted at a separate location on user 5 or on motorized exoskeleton unit 10.

In some examples, user 5 may receive various indications through MMI or transfer the user's command and shift motor's gear according to his will through another interface, e.g., a computer keyboard.

In some examples, motorized exoskeleton unit 10 may include a power unit 190. Typically, power unit 190 may be configured to be placed in, or coupled to, backpack 130. Power unit 190 may include rechargeable batteries and/or related circuitry. In some examples, power unit 190 may have an alternative power source. In some examples, power unit 190 may be powered by rechargeable batteries. In some examples, power unit 190 may be solar powered.

In some examples, brace segments may be worn adjacent to parts of the body of user 5.

In some examples, the braces may include a pelvis brace 150. Pelvis brace 150 may be worn on the trunk of user 5. In some examples, the braces may include thigh braces 160. Thigh braces 160 may be worn adjacent to the thighs of the user. In some examples, the braces may include leg braces 170. Leg braces 170 may be worn adjacent to the calves of the user. In some examples, the braces may include feet braces 175. Feet braces 175 may be configured to be coupled to the feet of user 5. Typically, stabilizing shoe braces may be attached to the bottom of the leg braces 170 and feet braces 175. Other braces configured to be coupled to other parts of user 5, as are known in the art may also be used.

Typically, motorized exoskeleton unit 10 may include straps 180. Straps 180 may, in some examples, ensure that each component brace described above of motorized exoskeleton unit 10 attaches to an appropriate corresponding part of the body of user 5. In some examples, other methods of attaching or coupling component braces, described above, as are known in the art may also be used. Typically, straps 180 may be made from a flexible material or fiber as are known in the art.

Typically, motion of the component brace may move the attached body part. In some examples, braces or other components of motorized exoskeleton unit 10 may be adjustable so as to enable optimally fitting motorized exoskeleton unit 10 to the body of a specific user. In some examples, the moved attached body part may not be able to move on its own. In some examples, the moved attached body part may otherwise be able to move on its own.

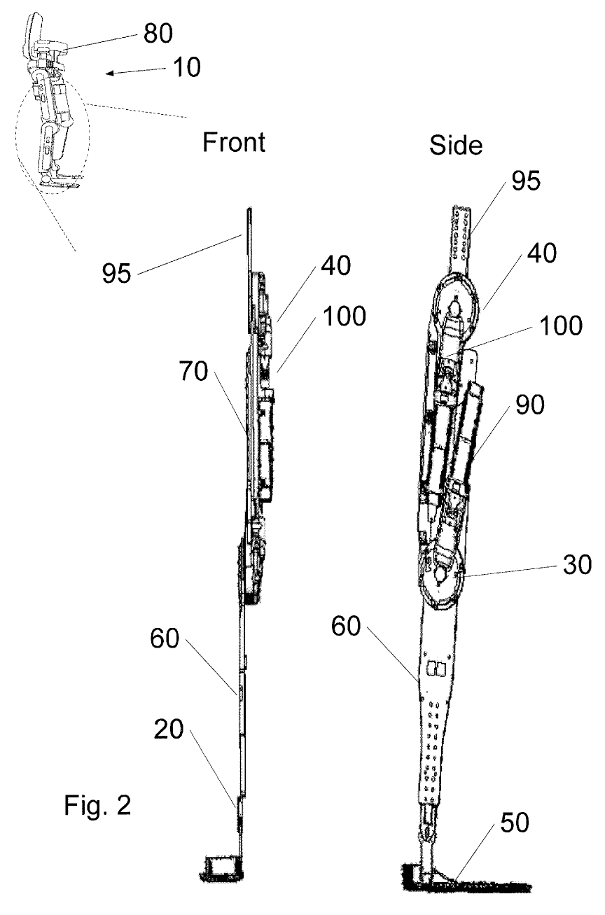

Reference is now made to FIG. 2, a schematic illustration of an example of components of a motorized exoskeleton unit, according to an example.

A schematic illustration of an example of a motorized exoskeleton unit 10 appears in the top corner of FIG. 2. An enlarged view of some components of motorized exoskeleton unit 10 according to some examples are depicted as representing a portion of the motorized exoskeleton unit. In some examples, these components are typically configured to be worn on each of the legs of user 5. Typically, user 5 may be disabled person, in varying degrees of disability, as described heretofore with reference to FIG. 1. In some examples, user 5 is not disabled, as described heretofore with reference to FIG. 1.

The components of motorized exoskeleton unit 10 are presented schematically in both a side view and a front view. The views are presented as exemplary schematics only and need not represent the side view and the front view of the same example.

Typically, motorized exoskeleton unit 10 includes support segments. In some examples, the support segments are configured to be coupleable to the body parts and particular positions on user 5.

In some examples, support segments of motorized exoskeleton unit 10 are configured to be coupleable to the thigh of user 5. In some examples, support segments are configured to be coupleable to the calf of user 5. In some examples, support segments may be configured to be coupleable to the torso of user 5, in some applications to a torso base 95.

In some examples, support segments may be configured to be coupleable to other lower extremities of user 5. Typically, a lower extremity lies below the navel. In some examples, a lower extremity may lie below the hips.

In some examples, support segments are configured to be coupleable to other positions on the body of user 5.

Typically, there may be one or a plurality of support segments of motorized exoskeleton unit 10 connected by an ankle joint 20. In some examples, there may be one or a plurality of support segments of motorized exoskeleton unit 10 connected by a knee joint 30. In some examples, there may be one or a plurality of support segments of motorized exoskeleton unit 10 connected by a hip joint 40.

In some examples, a foot support segment 50 of motorized exoskeleton unit 10 is typically connected to a calf segment 60 of motorized exoskeleton unit 10 via ankle joint 20,

In some examples, a calf support segment 60 of motorized exoskeleton unit 10 may be connected to a thigh support segment 70 of motorized exoskeleton unit 10 via knee joint 30.

In some examples, a hip support segment 80 of motorized exoskeleton unit 10 may be typically connected to thigh support segment 70 of motorized exoskeleton unit 10 via hip joint 40.

In some examples, other combinations known in the art, or additional support segments of motorized exoskeleton unit 10 and joints known in the art may also be coupleable to user 5.

In some examples, a support segment of motorized exoskeleton unit 10, typically, foot segment 50, may be configured to be adjacent to the foot of a user when motorized exoskeleton unit 10 is coupled to user 5.

In some examples, the motorized exoskeleton unit 10 may be coupled to user 5 via a band. In some examples, motorized exoskeleton unit 10 may be coupled to user 5 via a strap. In some examples, motorized exoskeleton unit 10 may be coupled to user 5 via other methods known in the art.

In some examples, a support segment of motorized exoskeleton unit 10, typically calf segment 60, may be configured to be adjacent to the calf of the user when motorized exoskeleton unit 10 is coupled to user 5.

In some examples, a support segment of motorized exoskeleton unit 10, typically thigh segment 70 may be configured to be adjacent to the thigh of the user, and superior to a support segment of motorized exoskeleton unit 10, typically calf segment 60.

In some examples, a joint for a support segment of motorized exoskeleton unit 10, typically hip joint 40 is configured to be adjacent to the hip of a person or user when motorized exoskeleton unit 10 is coupled to the user.

In some examples, these and/or additional support segment of motorized exoskeleton unit 10 may be configurable to be adjacent to other body parts or members of user 5.

Typically, one or a plurality of motors may be included in motorized exoskeleton unit 10. In some examples, one or a plurality of motors may be hip motor unit 100. In some examples, one or a plurality of motors may be knee motor unit 90. Typically, hip motor unit 100 and knee motor unit 90 are coupled to motorized exoskeleton unit 10.

In some examples, one or a plurality of motors may be included in and coupled to motorized exoskeleton unit 10. One or a plurality of hip motor unit 100, and one or a plurality of knee motor unit 90 are typically coupled to motorized exoskeleton unit 10.

In some examples, knee motor unit 90 may enable the knee of the user to achieve articulations to pivot so as to approximate or achieve natural walking movements.

In some examples, hip motor unit 100 may enable the hip of the user to achieve articulations to pivot so as to approximate or achieve natural walking movements.

In some examples, the combination of at least motor unit 90 and hip motor unit 100 may enable the knee of the user to achieve articulations to pivot so as to approximate or achieve natural walking movements.

In some examples, one or a plurality of hip motor unit 100, and one or a plurality of knee motor may comprise rotary motors. In some examples, motor units 90 and 100 may comprise linear motors or other motors or combinations of motors as are known in the art.

Typically, a linear motor may comprise a stator and a forcer (the rotor of the motor) is the movable part of the motor that moves.

In some examples, one or a plurality of motors may be coupled to thigh segment 70, typically this may include knee motor unit 90.Typically, knee motor unit may be a linear motor.

In some examples, one or a plurality of motors may be coupled to thigh segment 70; typically this may include a hip motor unit. Typically, hip motor unit 100 may be one of many types of motors, including a linear motor.

In some examples, hip motor unit 100 may be configured to be coupled to thigh segment 70 above or superior to knee motor unit 90.

In some examples, one or a plurality of knee motor unit 90 may be joint actuators, electric motors that spin a wheel or gear, linear actuators, or other actuators known in the art.

In some examples, one or a plurality of hip motor unit 100 may be joint actuators, electric motors that spin a wheel or gear, linear actuators, or other actuators known in the art.

In some examples, one or a plurality of hip motor unit 100 may be may be servomotors.

In some examples, one or a plurality of knee motor unit 90 may be may be servomotors.

In some examples, the servomotors may be stepper motors, or brushless electric motors that can divide a full rotation.

In some examples, one or a plurality of knee motor unit 90 may be piezo motors or ultrasonic motors.

In some examples, one or a plurality of hip motor unit 100 may be piezo motors or ultrasonic motors.

In some examples, one or a plurality of hip motor unit 100 may be linear actuators. In some examples, one or a plurality of knee motor unit 90 may be linear actuators.

In some examples, one or a plurality of hip motor unit 100 may include standard hydraulic cylinders or pneumatics. In some examples, one or a plurality of knee motor units may include standard hydraulic cylinders or pneumatics.

Typically, when one or a plurality of hip motor unit 100 includes electronic servomotors, the electronic servomotors may be efficient and power-dense, that may high-gauss permanent magnets and step-down gearing, may provide high torque and responsive movement.

Typically, when one or a plurality of knee motor units 90 includes electronic servomotors, the electronic servomotors may be efficient and power-dense, that may high-gauss permanent magnets and step-down gearing, may provide high torque and responsive movement

In some examples, a spring may be designed as part of the motor actuator in one or a plurality of knee motor units 90 to allow improved force control.

In some examples, a spring may be designed as part of the motor actuator in one or a plurality of hip motor units 100 to allow improved force control.

Typically, motorized exoskeleton unit 10 may be configured to move in a gait fashion, the gait fashion, in some examples, describable as series of prevented falls wherein the exoskeleton tilts forward. The tilting forward of motorized exoskeleton unit 10 may be configured to budge the motorized exoskeleton unit 10 from a stable position, typically resulting in a forward step.

The series of prevented falls may be further optimized by increasing the instability and/or imbalance of motorized exoskeleton unit 10. In some examples, increased instability may promoted by changing the distribution of the weight within motorized exoskeleton unit 10. In some examples, the weight distribution of motorized exoskeleton unit 10 may be configured via the placement of at least two motors, one or a plurality of knee motor unit 90 and one or a plurality of hip motor unit 100 above knee joint 30.

In some examples, when at least two motors, typically, one or a plurality of knee motor unit 90 and one or a plurality of hip motor unit 100, are coupled to thigh segment 70, the level of torque necessary to operate motorized exoskeleton unit 10 may be less than if one or a plurality of knee motor unit 90 was coupled to another support segment of the motorized exoskeleton unit, e.g. to calf segment 60 of motorized exoskeleton unit 10 and one or a plurality of hip motor unit 100 was coupled to a support segment of the motorized exoskeleton unit, superior to calf segment 60, e.g., to thigh segment 70 of motorized exoskeleton unit 10.

Typically, motorized exoskeleton unit 10 may be relatively easier to attach to user 5 when two motors, e.g., one or a plurality of knee motor unit 90 and one or a plurality of hip motor unit 100, are coupled to thigh segment 70 compared to examples, wherein knee motor unit 90 is coupled to the calf segment of motorized exoskeleton unit 10 and hip motor unit 100 is coupled to a segment superior to the calf segment.

In some examples, motorized exoskeleton unit 10 may be relatively easier to detach from user 5 when two motors, e.g., one or a plurality of knee motor unit 90 and one or a plurality of hip motor unit 100, are coupled to thigh segment 70 compared to examples, wherein knee motor unit 90 is coupled to the calf segment of motorized exoskeleton unit 10 and hip motor unit 100 is coupled to a segment superior to the calf segment.

In some examples, motorized exoskeleton unit 10 may be relatively easier to manipulate and adjust with regard to user 5 when two motors, e.g., one or a plurality of knee motor unit 90 and one or a plurality of hip motor unit 100, are coupled to thigh segment 70 compared to examples wherein knee motor unit 90 is coupled to the calf segment of motorized exoskeleton unit 10 and hip motor unit 100 is coupled to a segment superior to the calf segment.

In some examples, when two motors, e.g., one or a plurality of knee motor unit 90 and one or a plurality of hip motor unit 100, are coupled to thigh segment 70, the outward visibility to the user of motorized exoskeleton unit 10, and other people, may be less than in instances wherein—knee motor unit 90 is coupled to the calf segment of motorized exoskeleton unit 10 and hip motor unit 100 is coupled to a segment superior to the calf segment.

In some examples, when two motors, e.g., one or a plurality of knee motor unit 90 and one or a plurality of hip motor unit 100, are coupled to thigh segment 70, the motorized exoskeleton unit may not seem as bulky to the user of motorized exoskeleton unit 10, and other people, than in instances wherein—knee motor unit 90 is coupled to the calf segment of motorized exoskeleton unit 10 and hip motor unit 100 is coupled to a segment superior to the calf segment.

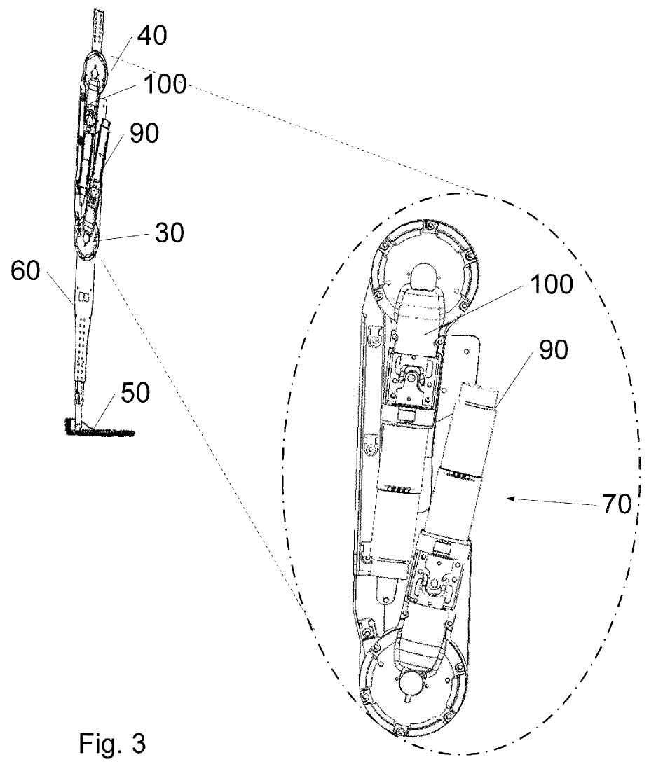

FIG. 3 depicts a close-up of a segment, typically thigh segment 70.

In some examples, thigh segment 70 may be a superior support segment within motorized exoskeleton unit 10.

In some examples, at least two motors, typically, one or a plurality of knee motor unit 90 and one or a plurality of hip motor unit 100, are coupled to thigh segment 70. As described above, the torque necessary to operate motorized exoskeleton unit 10 may be less when at least two motors, typically, one or a plurality of knee motor unit 90 and one or a plurality of hip motor unit 100, are coupled to thigh segment 70, than if one or a plurality of knee motor unit 90 was coupled to another support segment of the motorized exoskeleton unit, e.g. to calf segment 60 of motorized exoskeleton unit 10 and one or a plurality of hip motor unit 100 was coupled to a support segment of the motorized exoskeleton unit, superior to calf segment 60, e.g., to thigh segment 70 of motorized exoskeleton unit 10.

Features of various examples discussed herein may be used with other embodiments discussed herein. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

What is claimed is:

1. A motorized exoskeleton device for facilitating locomotion for a user, the device comprising:
a torso base for affixing to the torso of the user;
a pair of limb members configured to be coupled to a lower extremity of the user, each limb member comprising:
a first support segment and a second support segment, where the first support segment is superior to the second support segment;
two motorized joints, one of the motorized joints connecting the first support segment to the second support segment and an other motorized joint connecting the first support segment to the torso base; and
two motors configured to move the motorized joints,
wherein the motors are coupled to the superior support segment.

2. The motorized exoskeleton device of claim 1, wherein the two or plurality of motors are coupled to a thigh support segment of the motorized exoskeleton device.

3. The motorized exoskeleton device of claim 1, wherein the two or plurality of motors are configured to change a distribution of the weight of the motorized exoskeleton device.

4. The motorized exoskeleton device of claim 1, wherein the two or plurality of motors are configured to make it easier to attach the motorized exoskeleton device to a user.

5. The motorized exoskeleton device of claim 1, wherein the two or plurality of motors are configured to make it easier to detach the motorized exoskeleton device from a user.

6. The motorized exoskeleton device of claim 1, wherein the two or plurality of motors are a same type of motor.

7. The motorized exoskeleton device of claim 1, wherein the two or plurality of motors are different types of motors.

8. The motorized exoskeleton device of claim 1, wherein the motors are configured to add imbalance to the motorized exoskeleton device.

9. The motorized exoskeleton device of claim 1, wherein the superior support segment is adjacent to a thigh of a user.

10. The motorized exoskeleton device of claim 1, wherein the superior support segment is above a knee joint of a user.

11. The motorized exoskeleton device of claim 1, wherein the superior support segment is adjacent to a torso of a user.

12. The motorized exoskeleton device of claim 1, wherein the superior support segment is adjacent to a hip of a user.

13. The motorized exoskeleton device of claim 1, wherein the two or plurality of motors are configured to reduce a level of torque necessary to operate the motorized exoskeleton device.

14. The motorized exoskeleton device of claim 1, wherein a placement of the two or plurality of motors is configured to lessen an outward visibility of the motorized exoskeleton device.

15. The motorized exoskeleton device of claim 1, wherein a placement of the two or plurality of motors is configured to approximate or achieve natural walking movements.
